(19) United States
(12) Patent Application Publication
(10) Pub. No.: US 2024/0342875 A1
(43) Pub. Date: Oct. 17, 2024

(54) TOOL CONNECTOR

(71) Applicant: Ying-Mo LIN, Nantou County (TW)

(72) Inventor: Ying-Mo LIN, Nantou County (TW)

(21) Appl. No.: 18/591,914

(22) Filed: Feb. 29, 2024

(30) Foreign Application Priority Data
Apr. 14, 2023 (TW) 112203407

(51) Int. Cl. B25B 23/00

(52) U.S. Cl. CPC B25B 23/0035

(57) ABSTRACT

A tool connector is provided, wherein the tool connector includes: a main body including first and second tubular portions at opposing ends, a first elastic member being disposed on the first tubular portion and protrusive beyond an inner surface of the first tubular portion, a second elastic member being disposed on the second tubular portion and protrusive beyond an inner surface of the second tubular portion; a connection rod including an insertion portion including a small diameter section and a large diameter section, and a connection portion; wherein when the insertion portion is inserted in the first tubular portion, the first elastic member is radially abutted against the large diameter section, and when the insertion portion is inserted in the second tubular portion, the second elastic member is radially abutted against the small diameter section.

### BACKGROUND OF THE INVENTION

### Field of the Invention

The present invention relates to a tool connector.

### Description of the Prior Art

Generally, a tool connector is used in fastening operations. An end of the conventional tool connector is used to be connected to a rotational tool, and another end of the conventional tool connector is connected to a fastener. The tool connector is driven by the rotational tool to turn the fastener. However, since there are fasteners in various sizes, tool connectors in various sizes are required for respective fasteners in various sizes, which results in high purchase cost of purchasing the tool connectors and a large storage space.

The present invention is, therefore, arisen to obviate or at least mitigate the above-mentioned disadvantages.

### SUMMARY OF THE INVENTION

The main object of the present invention is to provide a tool connector which is applicable to fasteners of different sizes and avoids disengagement of the fastener.

To achieve the above and other objects, a tool connector is provided, wherein the tool connector includes: a main body including a first tubular portion and a second tubular portion at opposing ends, the first tubular portion having an inner diametric dimension larger than an inner diametric of the second tubular portion, a first elastic member being disposed on the first tubular portion and protrusive beyond an inner surface of the first tubular portion, a second elastic member being disposed on the second tubular portion and protrusive beyond an inner surface of the second tubular portion; a connection rod including an insertion portion and a connection portion, the insertion portion including a small diameter section and a large diameter section; wherein when the insertion portion is inserted in the first tubular portion, the first elastic member is radially abutted against the large diameter section, and when the insertion portion is inserted in the second tubular portion, the second elastic member is radially abutted against the small diameter section.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first exemplary embodiment of the present invention;

FIG. 2 is a breakdown drawing of the first exemplary embodiment of the present invention;

FIGS. 3 and 4 are cross-sectional views of the first exemplary embodiment of the present invention;

FIG. 5 is a stereogram of a second exemplary embodiment of the present invention;

FIG. 6 is a breakdown drawing of the second exemplary embodiment of the present invention; and

FIGS. 7 and 8 are cross-sectional views of the second exemplary embodiment of the present invention.

### DETAILED DESCRIPTION OF THE PREFERRED EMBODIMENTS

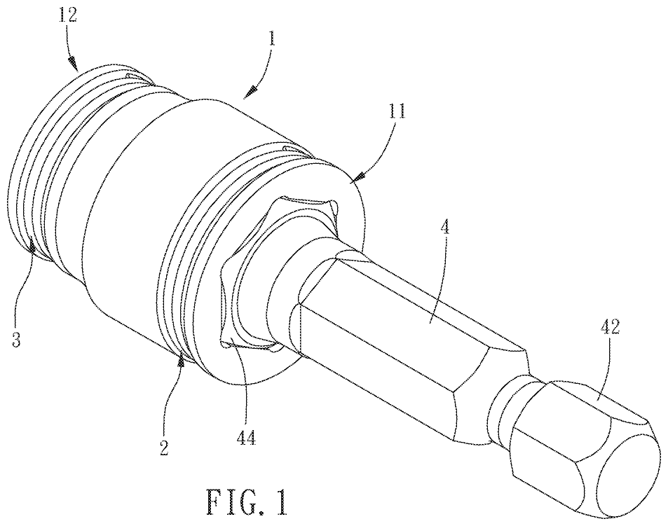

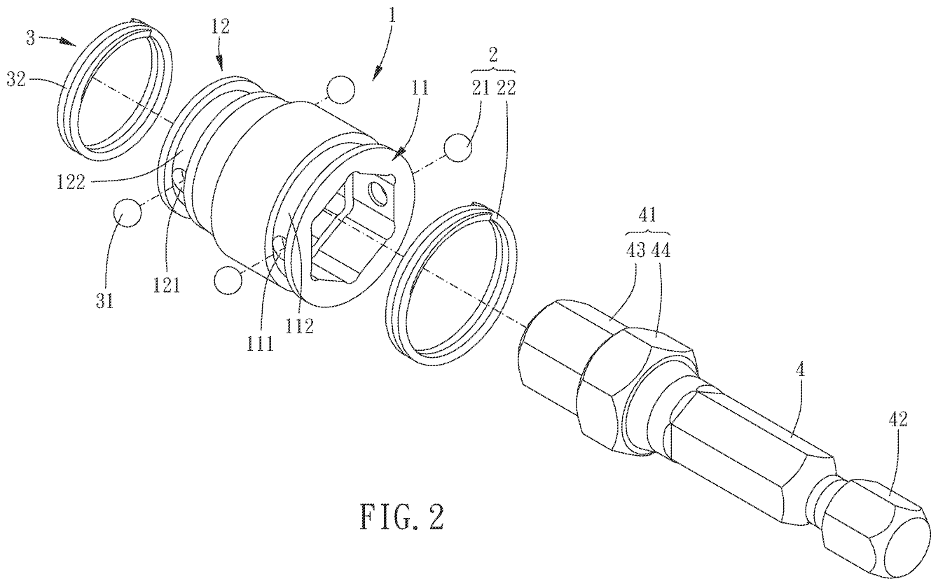

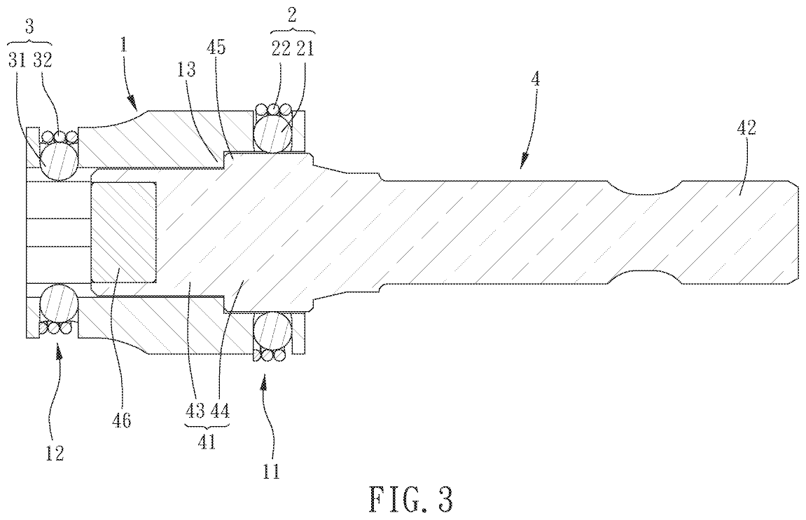

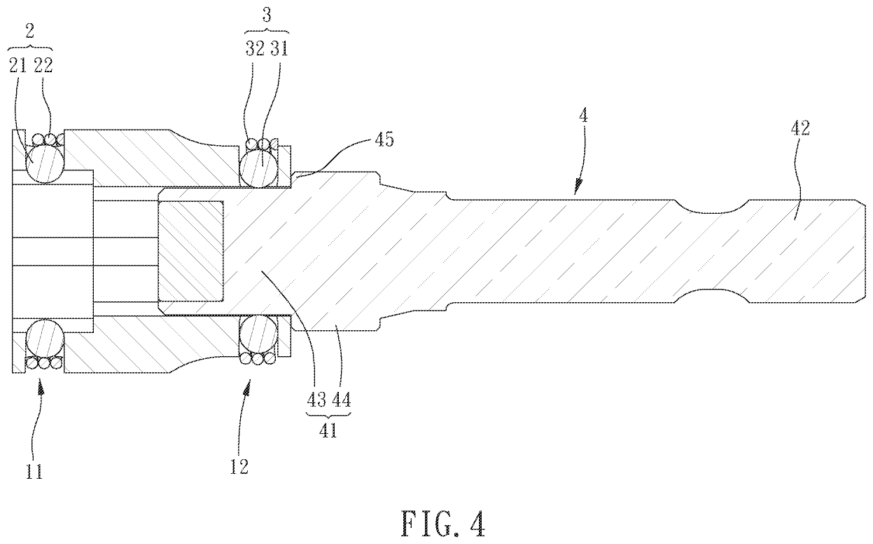

Please refer to FIGS. 1 to 4 for an exemplary embodiment of the present invention. A tool connector of the present invention includes a main body 1 and a connection rod 4.

The main body 1 includes a first tubular portion 11 and a second tubular portion 12 at opposing ends, the first tubular portion 11 has an inner diametric dimension larger than an inner diametric dimension of the second tubular portion 12, a first elastic member 2 is disposed on the first tubular portion 11 and protrusive beyond an inner surface of the first tubular portion 11, and a second elastic member 3 is disposed on the second tubular portion 12 and protrusive beyond an inner surface of the second tubular portion 12.

The connection rod 4 includes an insertion portion 41 and a connection portion 42, and the insertion portion 41 includes a small diameter section 43 and a large diameter section 44. The connection portion 42 is configured to be assembled to a rotational tool.

In this embodiment, the first tubular portion 11 and the second tubular portion 12 each include a non-circular hole (hexagonal hole), and the large diameter section 44 and the small diameter section 43 are non-circular columns (hexagonal columns). When the insertion portion 41 is inserted in first tubular portion 11, the first elastic member 2 is radially abutted against the large diameter section 44, which prevents the large diameter section 44 from disengaging from the first tubular portion 11, so that the second tubular portion 12 is configured to be assembled to a fastener such as a hexagonal bolt or screw and so that the second elastic member 3 is radially abutted against the fastener to prevent the fastener from disengaging from the second tubular portion 12. When the insertion portion 41 is inserted in the second tubular portion 12, the second elastic member 3 is radially abutted against the small diameter section 43, which prevents the small diameter section 43 from disengaging from the second tubular portion 12, so that the first tubular portion 11 is configured to be assembled to a larger fastener and so that the first elastic member 2 is radially abutted against the larger fastener to prevent the larger fastener from disengaging from the first tubular portion 11.

As such, the insertion portion 41 may be selectively inserted into the first tubular portion 11 or the second tubular portion 12 according to the size of the fastener, the insertion portion 41 and the fastener can be reliably retained. Moreover, the tool connector has a simple structure suitable for mass production

Specifically, the first tubular portion 11 includes at least one first hole 111 extending radially, the second tubular portion 12 includes at least one second hole 121 extending radially, the first elastic member 2 includes at least one first detent 21 and at least one first spring 22, the second elastic member 3 includes at least one second detent 31 and at least one second spring 32, the at least one first detent 21 is received in the at least one first hole 111, the at least one first spring 22 is disposed on the main body 1 and radially urges the at least one first detent 21, the at least one second detent 31 is received in the at least one second hole 121, and the at least one second spring 32 is disposed on the main body 1 and radially urges the at least one second detent 31.

Specifically, the first tubular portion 11 further includes a first outer annular groove 112, the first outer annular groove 112 is in communication with the at least one first hole 111, and the first spring 22 is annularly received in the first outer annular groove 112 and radially urges the at least one first detent 21 inwardly. The second tubular portion 12 further includes a second outer annular groove 122, the second outer annular groove 122 is in communication with the at least one second hole 121, the second spring 32 is annularly received in the second outer annular groove 122 and radially urges the at least one second detent 31 inwardly. In this embodiment, the at least one first detent includes two first detents 21, and the at least one second detent includes two second detents 31.

The large diameter section 44 is located between the connection portion 42 and the small diameter section 43, the first tubular portion 11 and the second tubular portion 12 are in communication with each other, a first shoulder 13 is disposed between the first tubular portion 11 and the second tubular portion 12, and a second shoulder 45 is disposed between the large diameter section 44 and the small diameter section 43. When the insertion portion 41 is inserted in first tubular portion 11, the first shoulder 13 and the second shoulder 45 are abutted against each other for positioning the insertion portion 41. When the insertion portion 41 is inserted in the second tubular portion 12, the second shoulder 45 is abutted against an end surface of the second tubular portion 12 remote from the first tubular portion 11 for positioning the insertion portion 41.

The small diameter section 43 has a length smaller than a length of the second tubular portion 12, which avoids in influence on the assembling of the fastener to the first tubular portion 11 or the second tubular portion 12 due to the unsuitable length of the small diameter section 43.

Preferably, an end surface of the small diameter section 43 remote from the large diameter section 44 includes a magnetic member 46 for magnetically attracting the fastener, and the large diameter section 44 has a diametric dimension larger than a diametric dimension of the connection portion 42.

Preferably, the first tubular portion 11 has an outer diametric dimension larger than an outer diametric dimension of the second tubular portion 12, so that the user can directly distinguish the first tubular portion 11 and the second tubular portion 12 through the appearance, which is more convenient in use.

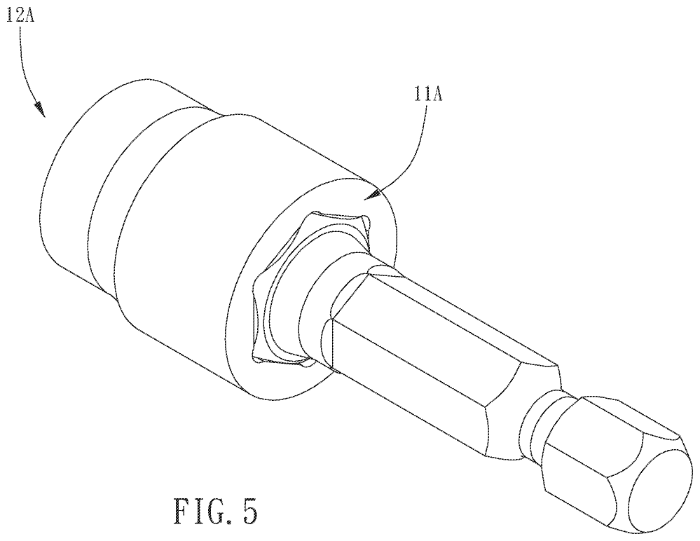

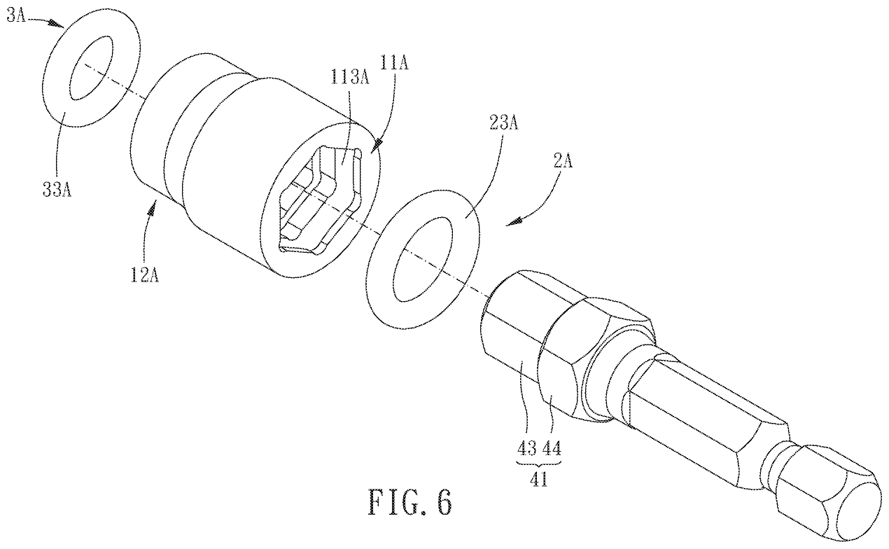

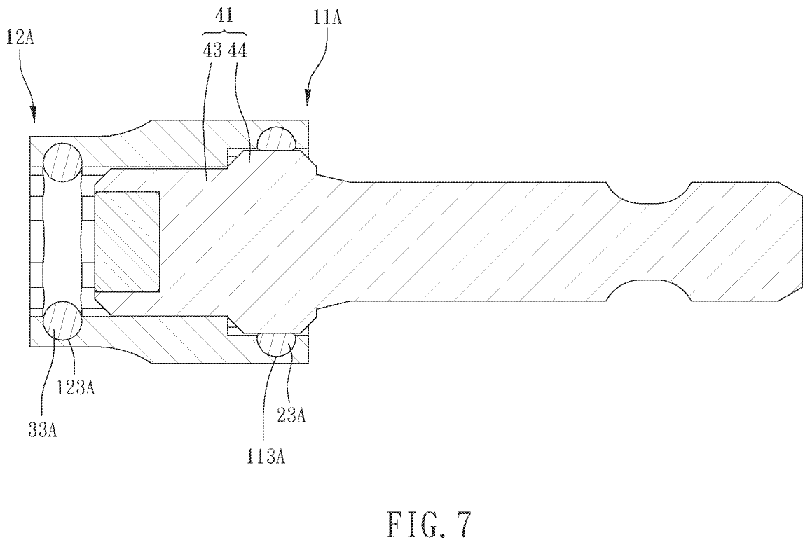

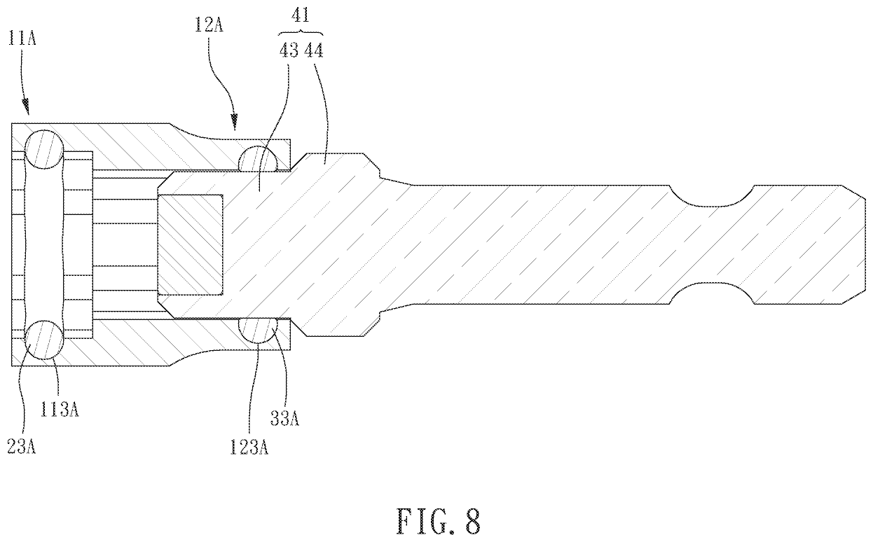

In a second embodiment shown in FIGS. 5 to 8, the first elastic member 2A includes a first engaging member 23A, the second elastic member 3A includes a second engaging member 33A, the first engaging member 23A and the second engaging member 33A are elastic rings, the first tubular portion 11A includes a first inner annular groove 113A, the second tubular portion 12A includes a second inner annular groove 123A, the first engaging member 23A is received in and radially protrusive beyond the first inner annular groove 113A, and the second engaging member 33A is received in and radially protrusive beyond the second inner annular groove 123A.

When the insertion portion 41 is inserted in the first tubular portion 11A, the first engaging member 23A is radially abutted against the large diameter section 44 to prevent the large diameter section 44 from disengaging from the first tubular portion 11A, so that the second tubular portion 12A is configured to be assembled to a fastener such as a hexagonal bolt or screw, and so that the second engaging member 33A is radially abutted against the fastener to prevent the fastener from disengaging from the second tubular portion 12A. When the insertion portion 41 is inserted in the second tubular portion 12A, the second engaging member 33A is radially abutted against the small diameter section 43, which prevents the small diameter section 43 from disengaging from the second tubular portion 12A, so that the first tubular portion 11A is configured to be assembled to a larger fastener and so that the first engaging member 23A is radially abutted against the larger fastener to prevent the larger fastener from disengaging from the first tubular portion 11A.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool connector including:
a main body including a first tubular portion and a second tubular portion at opposing ends, the first tubular portion having an inner diametric dimension larger than an inner diametric of the second tubular portion, a first elastic member being disposed on the first tubular portion and protrusive beyond an inner surface of the first tubular portion, a second elastic member being disposed on the second tubular portion and protrusive beyond an inner surface of the second tubular portion;
a connection rod including an insertion portion and a connection portion, the insertion portion including a small diameter section and a large diameter section;
wherein when the insertion portion is inserted in the first tubular portion, the first elastic member is radially abutted against the large diameter section, and when the insertion portion is inserted in the second tubular portion, the second elastic member is radially abutted against the small diameter section.

2. The tool connector of claim 1, wherein the first tubular portion includes at least one first hole extending radially, the second tubular portion includes at least one second hole extending radially, the first elastic member includes at least one first detent and at least one first spring, the second elastic member includes at least one second detent and at least one second spring, the at least one first detent is received in the at least one first hole, the at least one first spring is disposed on the main body and radially urges the at least one first detent inwardly, the at least one second detent is received in the at least one second hole, and the at least one second elastic member is disposed on the main body and radially urges the at least one second detent inwardly.

3. The tool connector of claim 2, wherein the first tubular portion further includes a first outer annular groove, the first outer annular groove is in communication with the at least one first hole, the first spring is annularly received in the first outer annular groove, the second tubular portion further includes a second outer annular groove, the second outer annular groove is in communication with the at least one second hole, and the second spring is annularly received in the second outer annular groove.

4. The tool connector of claim 1, wherein the large diameter section is located between the connection portion and the small diameter section, the first tubular portion and the second tubular portion are in communication with each other, a first shoulder is disposed between the first tubular portion and the second tubular portion, a second shoulder is disposed between the large diameter section and the small diameter section, when the insertion portion is inserted in first tubular portion, the first shoulder and the second shoulder are abutted against each other, and when the insertion portion is inserted in the second tubular portion, the second shoulder is abutted against an end surface of the second tubular portion remote from the first tubular portion.

5. The tool connector of claim 1, wherein the small diameter section has a length smaller than a length of the second tubular portion.

6. The tool connector of claim 1, wherein an end surface of the small diameter section remote from the large diameter section includes a magnetic member, and the large diameter section has a diametric dimension larger than a diametric dimension of the connection portion.

7. The tool connector of claim 1, wherein the first tubular portion and the second tubular portion each include a non-circular hole, and the large diameter section and the small diameter section are non-circular columns.

8. The tool connector of claim 1, wherein the first tubular portion has an outer diametric dimension larger than an outer diametric dimension of the second tubular portion.

9. The tool connector of claim 1, wherein the first elastic member includes a first engaging member, the second elastic member includes a second engaging member, the first engaging member and the second engaging member are elastic rings, the first tubular portion includes a first inner annular groove, the second tubular portion includes a second inner annular groove, the first engaging member is received in and radially protrusive beyond the first inner annular groove, and the second engaging member is received in and radially protrusive beyond the second inner annular groove.

10. The tool connector of claim 3, wherein the large diameter section is located between the connection portion and the small diameter section, the first tubular portion and the second tubular portion are in communication with each other, a first shoulder is disposed between the first tubular portion and the second tubular portion, a second shoulder is disposed between the large diameter section and the small diameter section, when the insertion portion is inserted in first tubular portion, the first shoulder and the second shoulder are abutted against each other, and when the insertion portion is inserted in the second tubular portion, the second shoulder is abutted against an end surface of the second tubular portion remote from the first tubular portion; the small diameter section has a length smaller than a length of the second tubular portion; an end surface of the small diameter section remote from the large diameter section includes a magnetic member, and the large diameter section has a diametric dimension larger than a diametric dimension of the connection portion; the first tubular portion and the second tubular portion each include a non-circular holes, and the large diameter section and the small diameter section are non-circular columns; the first tubular portion has an outer diametric dimension larger than an outer diametric dimension of the second tubular portion.
